(19) United States
(12) Patent Application Publication
(10) Pub. No.: US 2003/0119565 A1
(43) Pub. Date: Jun. 26, 2003

(54) Folding collapsible wireless transmitter-receiver earphone

(76) Inventor: Ming Hsun Lin, Tu Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/025,692

(22) Filed: Dec. 26, 2001

(51) Int. Cl. H04M 1/00

(52) U.S. Cl. 455/569

(57) ABSTRACT

A folding collapsible wireless transmitter-receiver earphone is constructed to include a base unit holding a circuit board and a speaker, the base unit having an axle holder at one end, and an extension unit holding a microphone, the extension unit having a short pivot shaft pivoted to the axle holder of the base unit and a wire passageway through which the signal line connecting the microphone to the circuit board passes.

### BACKGROUND OF THE INVENTION

1. Field of the Invention

The present invention relates to a wireless transmitter-receiver earphone and, more particularly to a folding collapsible wireless transmitter-receiver earphone.

2. Description of the Related Art

FIG. 1 illustrates a wireless transmitter-receiver earphone constructed according to the prior art. This structure of wireless transmitter-receiver earphone 7 comprises a base 71, a front extension 72 formed integral with and forwardly extended from one end of the base 71, and a clip 73 provided at the back side of the base 71 and adapted for securing the wireless transmitter-receiver earphone 7 to the ear. The base 71 has a jack 74 adapted for receiving a battery charger. Because the front extension 72 is adapted to hold the microphone (not shown) close to the user's mouth, it has a certain length. Because the front extension 72 is not folding collapsible and has a certain length, it tends to be broken after removal from the user's ear, and the wireless transmitter-receiver earphone needs much longitudinal storage space when not in use. In order to eliminate this problem, the front extension may be made pivoted to the base. However, the design of the folding structure must consider the possibility of damage to the signal line connected between the circuit board in the base and the microphone in the front extension during folding.

### SUMMARY OF THE INVENTION

The present invention has been accomplished to provide a wireless transmitter-receiver earphone, which eliminates the aforesaid drawbacks. It is therefore the main object of the present invention to provide a wireless transmitter-receiver earphone, which is folding collapsible. According to the present invention, the folding collapsible wireless transmitter-receiver earphone comprises a base unit, an extension unit extended from one end of the base unit, a circuit board mounted inside the base unit, a speaker mounted in the base unit and electrically connected to the circuit board, a microphone mounted in the extension unit, and a signal line connected between the circuit board and the microphone. The base unit comprises an axle holder disposed at one end thereof, the axle holder comprising a chamber disposed in communication with the inside space of the base unit and an opening in a bottom side of the chamber. The extension unit comprises a hollow pivot shaft transversely disposed at one end thereof and pivoted to the chamber of the base unit. The hollow pivot shaft has a side opening disposed in communication with the bottom opening of the axle holder for the passing of the signal line from the circuit board in the base unit to the microphone in the extension unit.

### BRIEF DESCRIPTION OF THE DRAWINGS

FIG. 1 is an elevational view of a wireless transmitter-receiver earphone constructed according to the prior art.

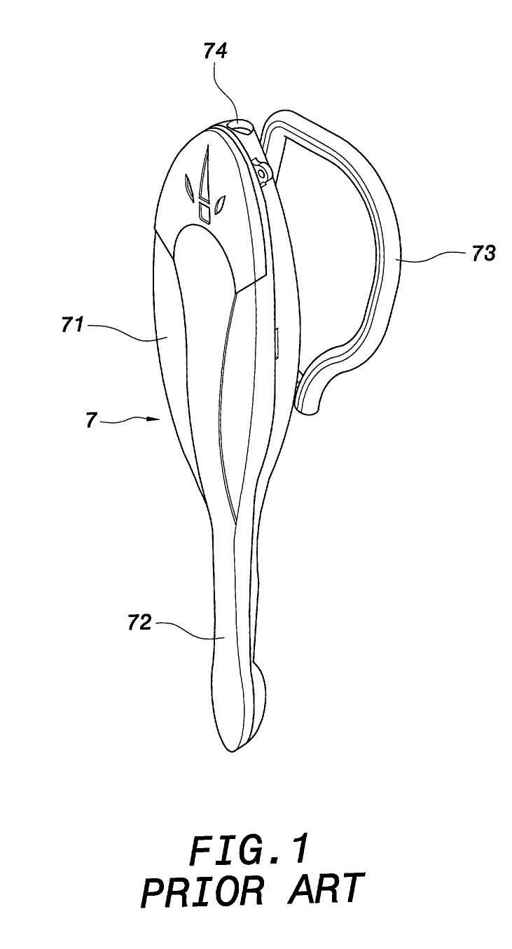

FIG. 2 is an exploded view of a folding collapsible wireless transmitter-receiver earphone according to the present invention.

FIG. 3 is an elevational view of the folding collapsible wireless transmitter-receiver earphone according to the present invention.

FIG. 4 is a sectional view of the folding collapsible wireless transmitter-receiver earphone according to the present invention.

FIG. 5 illustrates the folding collapsible wireless transmitter-receiver earphone folded up.

FIG. 6 illustrates an application example of the present invention.

### DETAILED DESCRIPTION OF THE PREFERRED EMBODIMENT

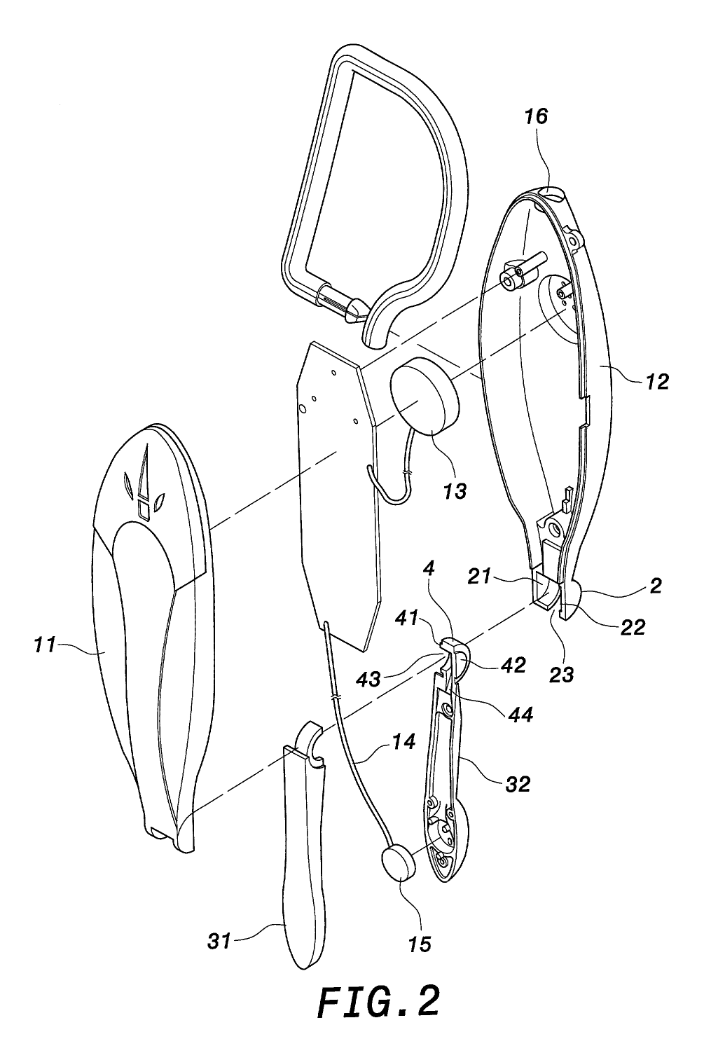

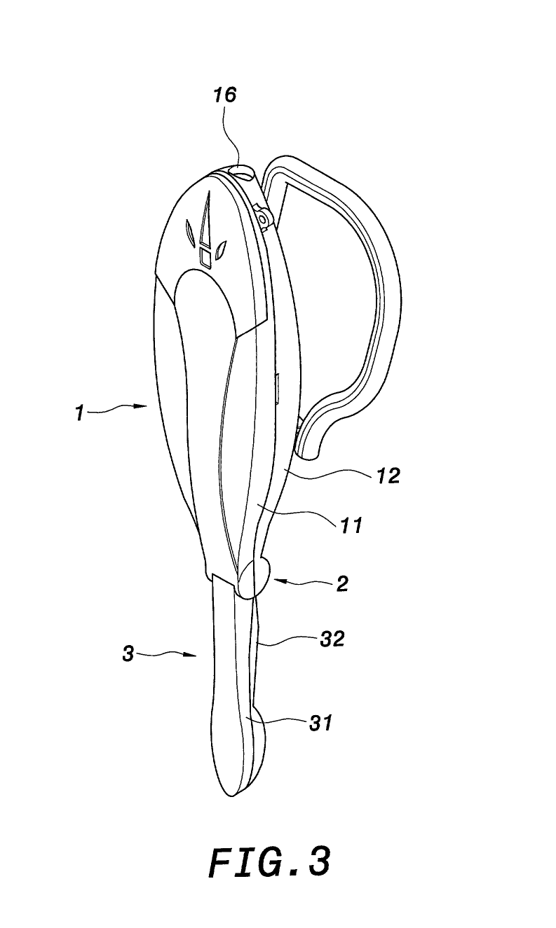

Referring to FIGS. 2 and 3, a folding collapsible wireless transmitter-receiver earphone in accordance with the present invention is shown comprised of a base unit 1, an extension unit 3. The base unit 1 and the extension unit 3 are respectively formed of front and back shells 11, 12; 31, 32. The base unit 1 holds a circuit board on the inside, which comprises a speaker 13 and a microphone 15. The microphone 15 is connected to the circuit board by a signal line 14. The base unit 1 comprises a jack 16 disposed at one end and adapted for receiving a battery charger, and an axle holder 2 disposed at the other end. The axle holder 2 comprises a chamber 21 disposed in communication with the inside space of the base unit 1, a coupling portion 22 at one lateral side of the chamber 21, and an opening 23 in the bottom side of the chamber 21. The extension unit 3 comprises a short hollow pivot shaft 4 transversely disposed at one end and pivotally coupled to the chamber 21 of the axle holder 2. The hollow pivot shaft 4 comprises a hollow shaft body 41. The hollow shaft body 41 has a coupling portion 42 pivotally coupled to the coupling portion 22 of the axle holder 2, a side opening 43 disposed in communication with the chamber 21, and a back wire passage hole 44 disposed in communication with the inside space of the extension unit 3.

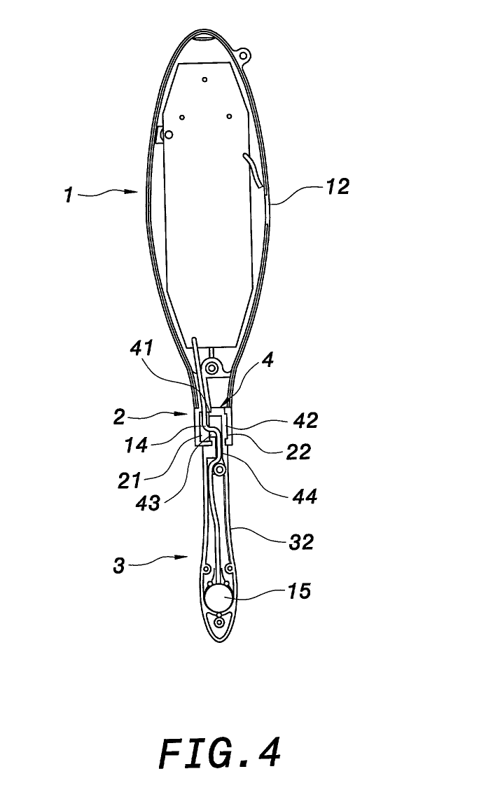

Referring to FIG. 4, the signal line 14 is inserted through the chamber 21 of the axle holder 2 and the side opening 43 and back wire passage hole 44 of the hollow shaft body 41 of the hollow pivot shaft 4 and extended to the inside of the extension unit 3, keeping the microphone 15 fixedly positioned in one end of the extension unit 3 remote from the hollow pivot shaft 4.

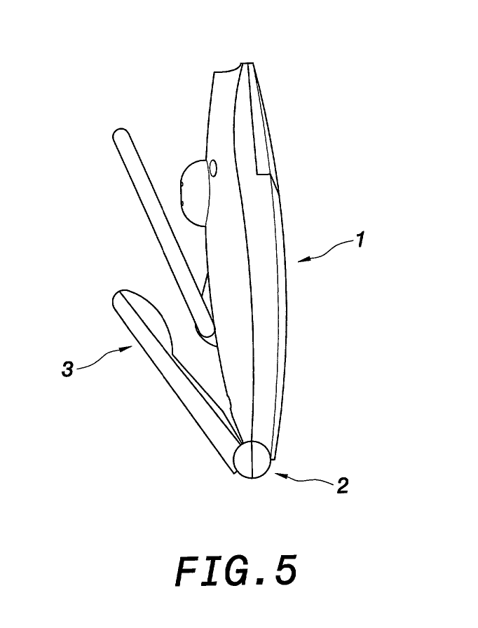

Referring to FIG. 5 and FIG. 4 again, when not in use, the extension unit 3 and the base unit 1 are folded up, preventing damage to the extension unit 3. Because the signal line 14 extends through the chamber 21 of the axle holder 2 and the side opening 43 and back wire passage hole 44 of the hollow shaft body 41 of the hollow pivot shaft 4 to the inside of the extension unit 3, folding up the folding collapsible wireless transmitter-receiver earphone does not twist or break the signal line 14.

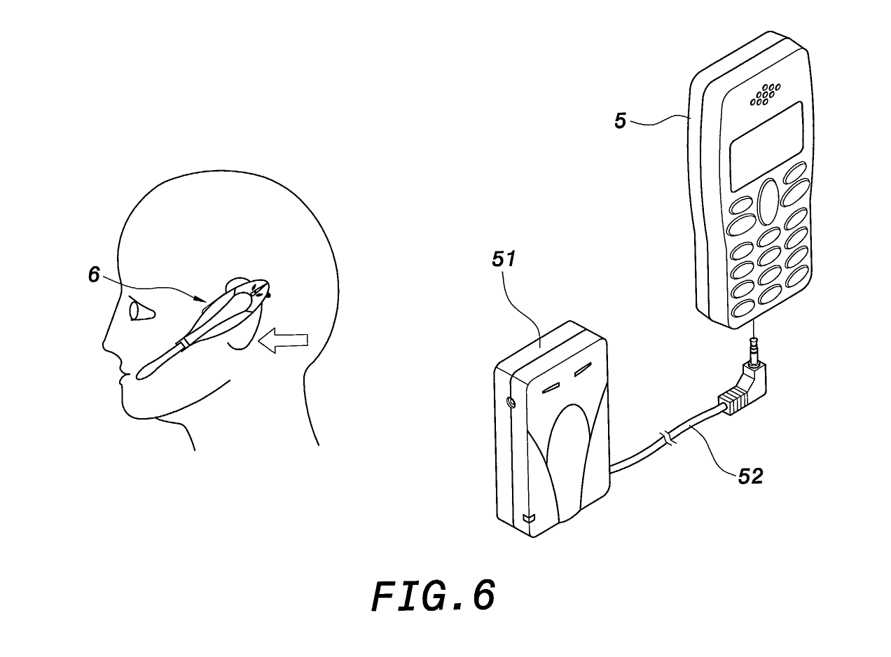

Referring to FIG. 6, the folding collapsible wireless transmitter-receiver earphone 6 can be used with a radio transceiver 51 to receive voice signal from a cellular telephone 5, or to transmit voice signal to a remote side through the cellular telephone 5. The radio transceiver 51 has a signal input/output line 52 connected to the earphone jack of the cellular telephone 5. The folding collapsible wireless transmitter-receiver earphone 6 can be constructed subject to use bluetooth technology to the radio transceiver 51 for use with the cellular telephone 5.

A protocol of folding collapsible wireless transmitter-receiver earphone has been constructed with the features of the annexed drawings of FIGS. 2˜6. The folding collapsible wireless transmitter-receiver earphone functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A folding collapsible wireless transmitter-receiver earphone comprising a base unit, an extension unit extended from one end of said base unit, a circuit board mounted inside said base unit, a speaker mounted in said base unit and electrically connected to said circuit board, a microphone mounted in said extension unit, and a signal line connected between said circuit board and said microphone, wherein said base unit comprises an axle holder disposed at one end thereof, said axle holder comprising a chamber disposed in communication with the inside space of said base unit and an opening in a bottom side of said chamber; said extension unit comprises a hollow pivot shaft transversely disposed at one end thereof and pivoted to the chamber of said base unit, said hollow pivot shaft having a side opening disposed in communication with the bottom opening of said axle holder for the passing of said signal line from the circuit board in said base unit to the microphone in said extension unit.

2. The folding collapsible wireless transmitter-receiver earphone as claimed in claim 1, wherein said axle holder comprises a hollow shaft body inserted into said chamber of said axle holder, said hollow shaft body having a coupling portion disposed at one lateral side opposite to said side opening and pivotally coupled to the coupling portion of said axle holder.

3. The folding collapsible wireless transmitter-receiver earphone as claimed in claim 1, wherein said hollow shaft body has a back wire passage hole disposed in communication with the side opening of said hollow shaft body and the bottom opening of said axle hole for the passing of said signal line from the circuit board in said base unit to the microphone in said extension unit.
